(19) United States
(12) Patent Application Publication
(10) Pub. No.: US 2008/0174434 A1
(43) Pub. Date: Jul. 24, 2008

(54) PERMANENTLY DESTRUCTIBLE RESONANT CIRCUIT WITH NON-SELF-HEALING CAPACITOR

(75) Inventors: Seth Strauser, Sewell, NJ (US); Charles Iacono, Mount Laurel, NJ (US); Lawrence Appalucci, Villanova, PA (US)

Correspondence Address: CAESAR, RIVISE, BERNSTEIN,;COHEN & POKOTILOW, LTD., 11TH FLOOR, SEVEN PENN CENTER, 1635 MARKET STREET, PHILADELPHIA, PA, 19103-2212, US

(73) Assignee: CHECKPOINT SYSTEMS, INC., Thorofare, NJ (US)

(21) Appl. No.: 12/015,790

(22) Filed: Jan. 17, 2008

Related U.S. Application Data
(60) Provisional application No. 60/885,531, filed on Jan. 18, 2007.
(60) Provisional application No. 60/980,948, filed on Oct. 18, 2007.

(51) Int. Cl. G08B 13/181

(52) U.S. Cl. 340/572.3

(57) ABSTRACT

A resonant circuit for use with a radio-wave detection system for the prevention of shoplifting or the like which has a coil and capacitor circuit whereby the circuit is permanently destroyed when the tag is exposed to a radio signal that causes a voltage across the capacitor that exceeds the breakdown voltage of the capacitor. The capacitor comprises a dielectric that does not exhibit self-healing. Such dielectrics include ceramics, metal oxides and minerals.

### CROSS-REFERENCE TO RELATED APPLICATIONS

This utility application claims the benefit under 35 U.S.C. §119(e) of Provisional Application Ser. No. 60/885,531 filed on Jan. 18, 2007 and entitled RF Label for Container Stopper or Cap and Provisional Application Ser. No. 60/980,948 filed on Oct. 10, 2007 and entitled Permanently Destructible Resonant Circuit with Non-Self-Healing Capacitor and both of whose entire disclosures are incorporated by reference herein.

### BACKGROUND OF THE INVENTION

1. Field of Invention

The present invention relates to a resonant circuit used for the prevention of shoplifting or the like, and more particularly, to a resonant circuit having a capacitor that is permanently deactivated by exposure to a predetermined voltage level.

2. Description of Related Art

In retail shops, libraries or the like, a surveillance system including a resonant tag that resonates with a radio wave, a transmitting antenna and a receiving antenna has been used for the prevention of shoplifting. In an embodiment, the resonant tag is composed of an insulating film, a coil and a plate made of a conductive metal foil formed on one side of the insulating film, and a plate made of a conductive metal foil formed on the other side, which constitute an LC circuit and resonates with a radio wave at a particular frequency. In another embodiment, the resonant tag is composed of a wire loop and a discrete capacitor, both of which are embedded in or affixed to an object to be protected from theft. An example of this type of tag includes a bottle stopper, such as a wine bottle stopper wherein the wire loop inductor and discrete capacitor are connected in parallel and installed inside the bottle stopper. Copending provisional application 60/885,531 discloses such a device.

If an article with the resonant circuit attached passes through a surveillance area without being disabled at checkout, the resonant circuit resonates with the radio wave from the transmitting antenna, and the receiving antenna detects the resonance and generates an alarm. A typically used resonant frequency is 5 to 15 MHz, because frequencies within the range can be easily distinguished from various noise frequencies. In electric article surveillance (EAS), a frequency of 8.2 MHz is most popularly used, and in radio frequency identification (RFID), a frequency of 13.56 M is most popularly used.

By way of example only, FIGS. 1-3 depict a prior art LC resonant circuit in the form of a tag 10 which includes a coil 11 and a first capacitor plate 12 on one side (FIG. 1) of a substrate 13 and a second capacitor plate 14 on the other side of the substrate 13 (FIG. 2). FIG. 3 is a cross-sectional view of this prior art tag showing a typical substrate thickness, t, of approximately 20 microns, which tends to be the thinnest dielectric that can be formed using conventional dielectric forming methods (e.g., extruding polyethylene between the metal layers). Adhesive layers 15 and 17 secure the metal layers to the substrate 13 respectively.

Prior art resonant tags formed as in FIGS. 1-4 are commonly deactivated, once an article with the resonant tag is purchased, by application of a predetermined voltage to the tag. The tag typically has a thinned part of the dielectric where the induced voltage across the capacitor plates 12, 14 causes dielectric breakdown, thereby making the resonant tag incapable of resonating with a radio wave at a predetermined frequency. This means for deactivating a resonant tag is shown in FIG. 4. FIG. 4 shows a portion of a capacitor formed by upper and lower metal plates 2,3 affixed to a dielectric 4 with adhesive layers 5A, 5B. The plates, which are typically metal foil or the like are dimpled 10A, 10B to form a narrowed area in the dielectric 4. When sufficient voltage is applied to the capacitor, a short forms across the narrowed area of the dielectric. The short disables the capacitor and the tag will no longer resonate. A common problem with this type of deactivation means occurs where the tag is incorporated into or attached to an article of clothing and must remain deactivated for the useful life of the clothing. Often, the dielectric, which has been shorted as described above, heals itself when the clothing is worn or washed. Many dielectrics are also known to heal over time, without any physical agitation. In resonant tags having polyethylene dielectrics, as many as 50% ofthe tags become reactivated with wearing or laundering. This unintended reactivation has undesirable consequences for the wearer of the clothing, who will activate security tag detection devices when exiting any store with equipment tuned to the tag's resonant frequency. Not only is the false alarm inconvenient and embarrassing for the person wearing the clothing with the reactivated tag, but frequent false alarms can cause a “boy who cried wolf” effect. Store personnel can become lax about enforcement of tag alarms when many of them are falsely triggered by reactivated tags on legitimately purchased goods. The inconvenience and embarrassment of false alarms may so irritate consumers that sales of clothing brands bearing re-activatable tags are lost.

One alternative to resolve the self-healing dielectric problem is to use a fuseable circuit element instead of a capacitor as the deactivation means. Resonant circuits that are deactivated by applying a high voltage that causes sufficient current to vaporize a fuseable link are described in U.S. Pat. No. 5,861,809. This patent and all other references in this application are incorporated into this application by reference. The fuseable link does not self-heal, and thus, resonant circuits that are deactivated by this means are permanently deactivated, with no chance of self-healing. Typically, a fuseable link 36 is installed in a gap in the coil portion 70 of a tag, as shown in FIG. 5. the fuseable link can be connected to the coil by wire bonded wires 40, 42 or by conductive epoxies or other means.

One drawback of the fuseable link is that the narrowed area in the fuse that is designed to destruct under high current has a relatively high resistance compared to the rest of the circuit elements. This increased resistance lowers the Q of the resonant circuit. Resonant circuits with a low Q produce a weaker resonant signal and must be placed closer to deactivation circuitry in order to generate sufficient current to destroy the fuse, which is burdensome for checkout personnel. Low Q also requires that the resonant circuit coil be physically larger to generate sufficient current for deactivation and to be detected. Larger circuits naturally have higher manufacturing costs and are less desirable as they are more difficult to conceal in merchandise to be protected.

Thus a need exists for an improved resonant circuit that can be permanently disabled.

### BRIEF SUMMARY OF THE INVENTION

An object of the present invention is to provide a resonant circuit mainly used in a radio-wave detection system for the prevention of shoplifting or the like that is permanently disabled by application of a predetermined voltage which causes permanent breakdown of a capacitor located in the circuit.

As a result of earnest study, the inventors have found that the object described above can be attained if a ceramic capacitor or other form of capacitor having a predetermined breakdown voltage at which permanent dielectric breakdown results is included in the LC circuit of the resonant circuit, and achieved the present invention.

Briefly, the present invention is as follows. A resonant tag resonates with a radio wave at a predetermined frequency and comprises: an inductor, which can be a coil formed in essentially two dimensions and made of a metal foil or printed with a conductive material or a wire loop inductor, and a ceramic or other non-reversible dielectric capacitor having a predetermined breakdown voltage, such that, once that voltage is exceeded, the capacitor is permanently disabled, thus permanently disabling the LC resonant circuit.

In another embodiment, a resonant circuit resonates with a radio wave within a predetermined resonant frequency range. The resonant circuit includes an inductor; and a capacitor having a predetermined dielectric breakdown voltage. The inductor and capacitor form an LC circuit and the resonant circuit is permanently disabled by inducing a voltage to the capacitor that exceeds the predetermined breakdown voltage. The capacitor dielectric can be made of a ceramic, metal oxide or mineral substances.

Another embodiment is a circuit element adapted for use in a resonant circuit. The circuit element is in the form of a strap having two electrically conductive ends. The electrically conductive ends are connected to each other by a dielectric material forming a capacitor having a predetermined breakdown voltage. The dielectric material can be made of a ceramic, metal oxide or mineral substances.

### BRIEF DESCRIPTION OF SEVERAL VIEWS OF THE DRAWINGS

The invention will be described in conjunction with the following drawings in which like reference numerals designate like elements and wherein:

FIG. 1 is an enlarged plan view of one side of a prior art resonant tag;

FIG. 2 is an enlarged plan view of the other side of the prior art resonant tag of FIG. 1;

FIG. 3 is a cross-sectional view of the prior art resonant tag taken along line 3-3 of FIG. 1;

FIG. 4 is a cross-sectional view of a narrowed area in a prior art resonant tag;

FIG. 5 is a prior art planar resonant circuit with a fuseable link;

FIG. 6 is a plan view of an exemplary resonant tag with wire-bonded ceramic capacitor;

FIG. 7 is a cross-sectional view of the wire-bonded ceramic capacitor of FIG. 6;

FIG. 7a is a cross sectional view of a surface mount ceramic capacitor;

FIG. 8 is a plan view of an exemplary resonant circuit with a conductive strap;

FIG. 8a is a cross-sectional view of an exemplary conductive strap installed on the resonant circuit of FIG. 8 and taken along line 8-8;

FIG. 9 is a plan view of an exemplary resonant tag having a ceramic capacitor mounted on a strap;

FIG. 10 is a cross-sectional view of the tag of FIG. 9 taken along line 10-10 of FIG. 9;

FIG. 11 is a plan view of an exemplary capacitor strap for use in a resonant tag;

FIG. 12 is cross-sectional view of the capacitor strap of FIG. 11, taken along line 2-2;

FIG. 12a is a cross-sectional view of another version of the capacitor strap of FIG. 11 taken along line 2-2,

FIG. 12b is a cross-sectional view of a capacitor strap having an insulating layer on the bottom;

FIG. 13 is a plan view of an exemplary resonant tag having a capacitor strap as in FIGS. 11-12;

FIG. 14 is a cross-sectional view of the tag of FIG. 13 taken along line 14-14;

FIG. 15 is an exploded view of a resonant circuit for use in a bottle stopper;

FIG. 16 is a cut-away view of a resonant circuit in a bottle stopper.

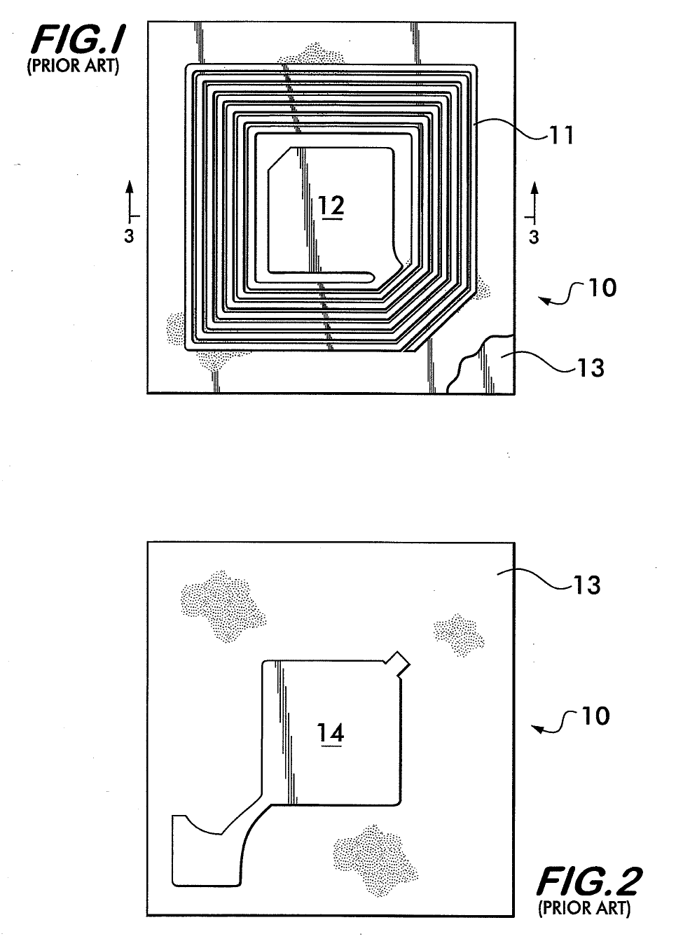

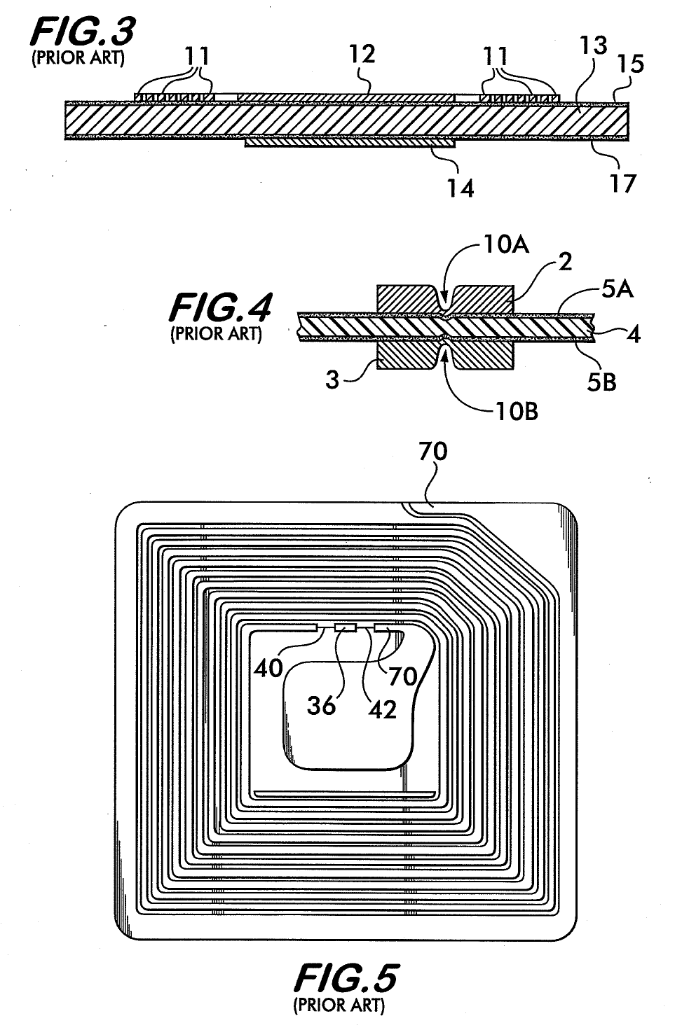

### DETAILED DESCRIPTION OF THE INVENTION

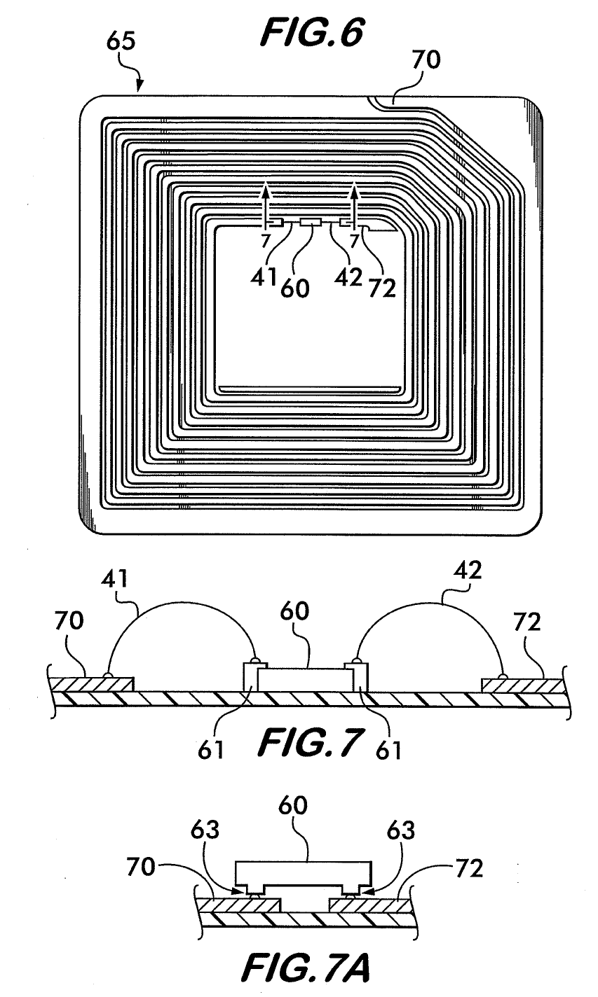

In an exemplary embodiment, an LC resonant circuit 65 is formed on a substantially planar substrate as shown in FIGS. 6 and 7. The frequency (f) at which the LC circuit resonates is determined by the values of L and C in the following equation:

$$f = \frac{1}{2 π \sqrt{LC}}$$

In this embodiment, the capacitor 60 is a chip capacitor with contacts 61 suitable for wire bonding. An inductor is formed by a coil 70 of conductive material, which can be metal foil, a printable conductive material or like means known in the art. In order for the tag to form a closed LC circuit, the open end of the inductor coil 70 and the metal foil connected to the open end of the capacitor 72 must be connected together. Means for achieving this are known in the art, and include, a separate conductor on the underside of the tag that connects the two ends 70 and 72. In this embodiment, the conductors on the top and bottom sides of the tag are separated by an insulation material, which can also be a substrate for the tag. The insulation material is pierced in order to made electrical contact between the upper and lower layers. Such an embodiment is shown in prior art FIG. 3, where conductive material 11, 12 on the top side of the tag is adhered to an insulator material 13 with an adhesive 15 and conductive material 14 is adhered to the bottom side of the insulator material 13 with an adhesive 17.

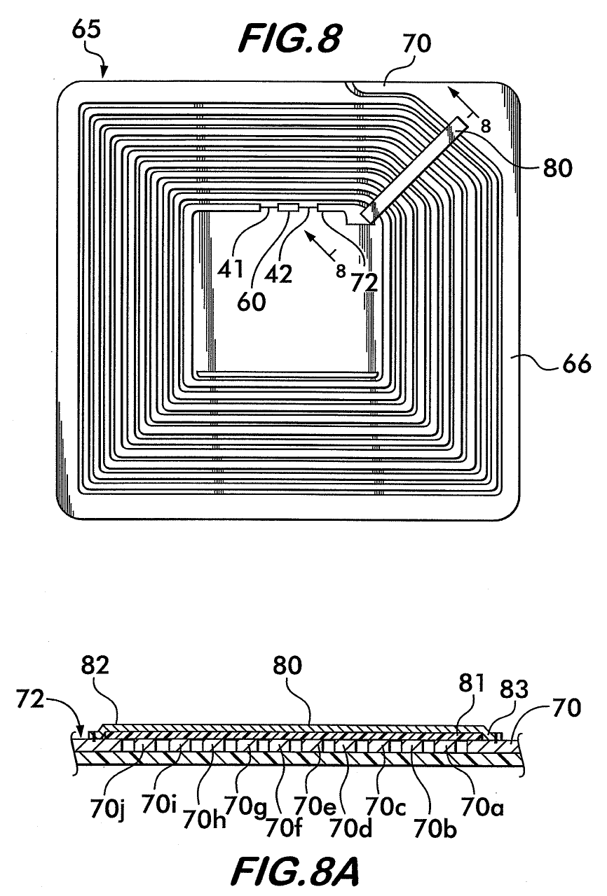

Connection between the open inductor end 70 and the open capacitor end 72 can also be by a separate conductive strap 80 installed on top of the conductive material of the tag 65, as shown in FIG. 8. and 8a. The separate conductive strap 80 has exposed ends 82 and 83 that make direct contact with the ends 70 and 72 of the conductor. The conductive strap also has electrical insulation 81 that covers the area where the strap crosses traces 70a-j of the inductor. The conductive strap is electrically connected at its ends 82, 83 to the conductive material of the tag 70, 72. This can be by hot or cold welding, conductive epoxy or other like means known in the art. These modes of attachment and the use of a strap in particular are disclosed in co-pending U.S. patent application Ser. No. 11/539,995.

An alternate embodiment for connecting the capacitor to the conductive elements of the tag, is shown in FIG. 7a. In this embodiment, the capacitor 60 is a capacitor that is in the form suitable for surface mount attachment, having solder bumps 63 on its underside. The solder bumps are made to electrically and physically bond the capacitor to the conductive material 70, 72 of the tag. Surface mount devices and means for establishing electrical connections with solder bumps are well known in the art.

The capacitor has the following features. The capacitor must be non-self healing upon dielectric breakdown. Typical dielectric materials include ceramic, metal oxides and minerals such as mica. In a preferred embodiment, the dielectric has a breakdown voltage of 3-10 volts DC. In a preferred embodiment, the dielectric has a total thickness of 60-2000 angstroms. In a preferred embodiment, the resonant circuit formed as described above has a Q of between 55 and 90.

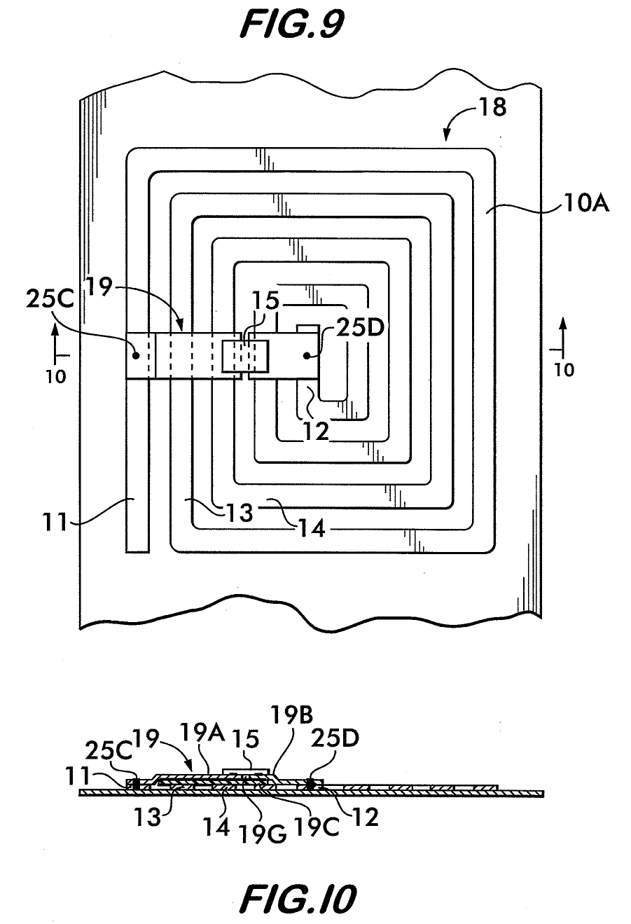

In a further embodiment, the capacitor is attached to a strap-like device similar to that described above and in co-pending application Ser. No. 11/539,995. FIGS. 9-10 depict the use of the strap 19 with a chip capacitor 15 attached, being used on a coil 10A to form an LC resonant tag. A chip capacitor includes capacitors formed on a silicon substrate. The capacitor strap 19 is electrically coupled to the coil at points 25D, 25C in a manner similarly discussed with regard to FIGS. 8 and 8a, including attachment means such as hot and cold welding and conductive epoxy. The capacitor strap 19 comprises a capacitor 15 that is electrically connected to conductive flanges 19A and 19B. A gap 19G separates these two flanges to prevent shorting the capacitor 15 electrical contacts (not shown). The conductive flanges 19A and 19B are electrically coupled to respective locations 11, 12 of the coil 10A at connections 25C and 25D, respectively. To prevent shorting the capacitor 15 to coil elements 13, 14 when the capacitor strap 19 is electrically coupled to the coil 10A, an insulating layer 19C (e.g., paper) is disposed between the conductive flanges 19A/19B and the coil 10A, as shown most clearly in FIG. 10.

A further embodiment is shown in FIGS. 11-13. In this embodiment, a strap that connects electrically to both ends of a planar inductor as described above, is formed with an integral capacitor. A capacitor strap 20 is electrically coupled to an EAS or RFID coil or antenna, by electrically connecting the non-overlapping ends 22B of the first electrically conductive planar element 22 and the non-overlapping end 24B of the second electrically conductive planar element 24 to respective portions of the coil or antenna. The capacitor strap is a thin component for electrically bridging at least two respective portions of an antenna or coil component of an EAS or RFID tag or inlay. The strap component exhibits a desired capacitance and has a predictable breakdown voltage range that causes irreversible breakdown. The capacitor strap comprises a first electrically conductive planar element 22 and a second electrically conductive planar element 24, and a planar dielectric layer 24A, 22A disposed between at least portions of the first and second electrically conductive planar elements.

The first electrically conductive 22 element includes a first portion arranged to be secured in electrical continuity with one of the at least two respective portions of the antenna or coil. The second electrically conductive element 24 includes a first portion arranged to be secured in electrical continuity with another of the at least two respective portions of the antenna or coil, resulting in the formation of the EAS or RFID tag or inlay. A capacitor formed in this manner, but with a flexible polymer dielectric is described in co-pending U.S. patent application Ser. No. 11/539,995 filed on Oct. 10, 2006, which is incorporated herein by reference.

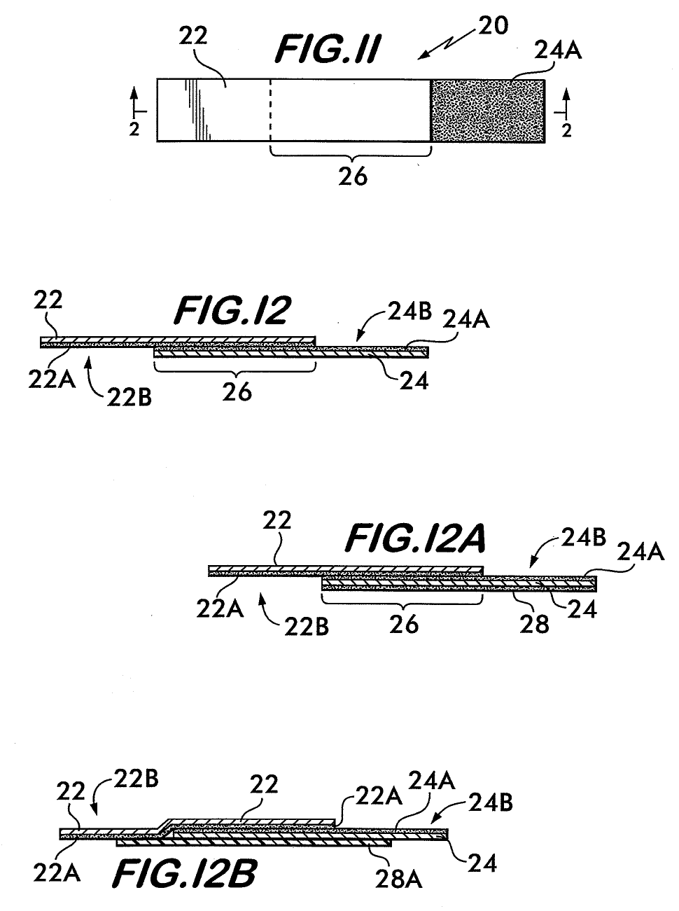

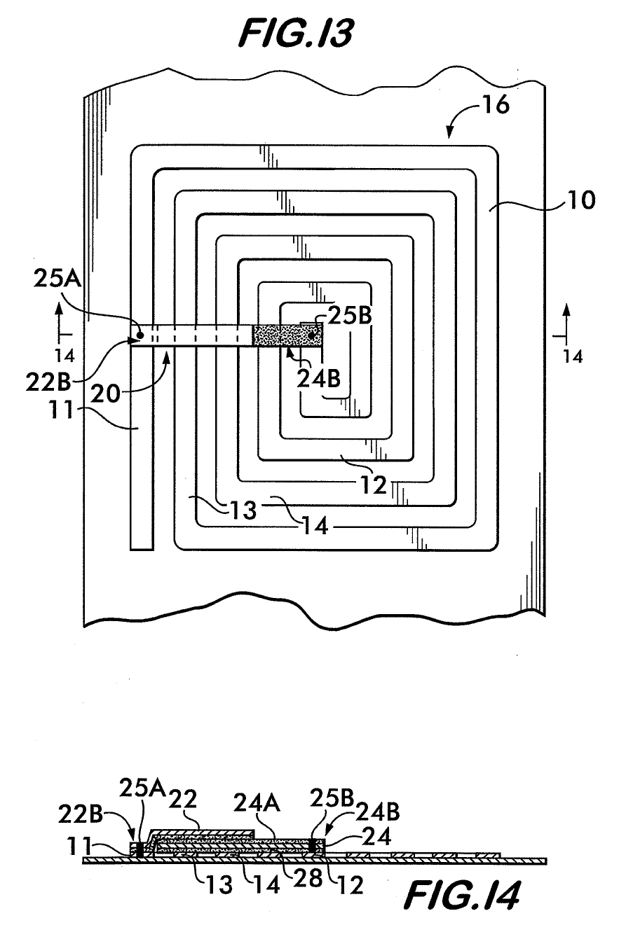

FIG. 11 depicts an enlarged plan view of a capacitor strap 20. As can be seen most clearly in FIG. 12, the capacitor strap 20 comprises a first electrically conductive planar element 22 having an associated ceramic dielectric layer 22A and a second electrically conductive planar element 24 having an associated ceramic dielectric layer 24A and wherein portions of the elements 22 and 24 overlap 26, thereby forming a capacitor. As is known to those skilled in the art, the amount of overlap 26 determines the capacitance. The dielectric must be such that once the capacitor breakdown voltage is exceeded, the capacitor cannot self-heal. Exemplary dielectric materials include ceramics, metal oxides and minerals.

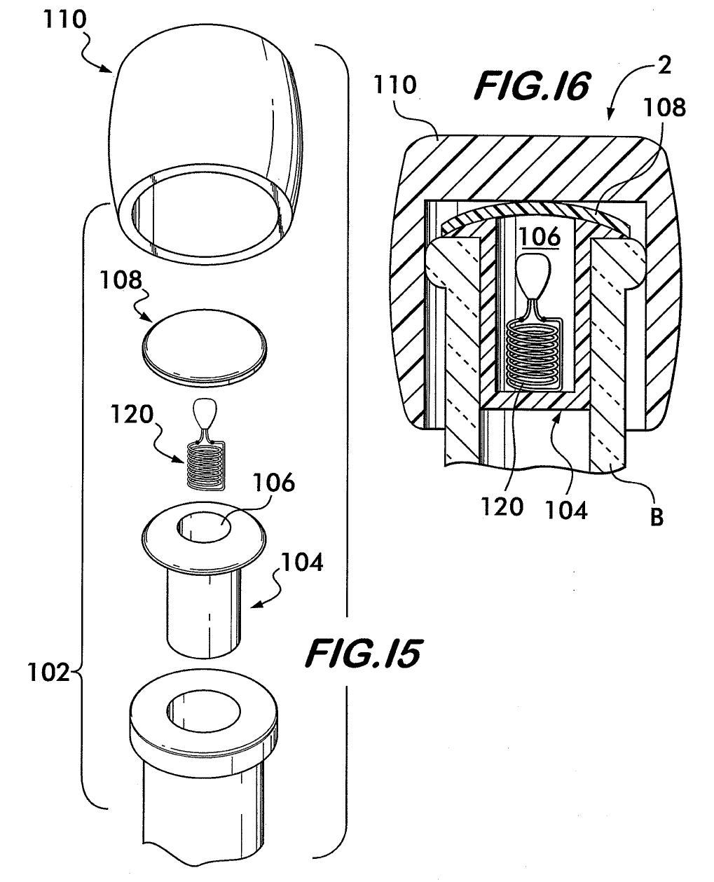

A capacitor strap 20 is electrically coupled to an EAS or RFID coil or antenna, by electrically connecting the non-overlapping ends 22B of the first electrically conductive planar element 22 and the non-overlapping end 24B of the second electrically conductive planar element 24 to respective portions of the coil or antenna. Where the coil or antenna comprises several turns, for example as shown by the coil 10 in FIG. 13, in order to prevent shorting of the second electrically conductive planar element 24, an insulator layer 28 (FIG. 12A, e.g., a dielectric material), or paper insulator layer 28A (FIG. 12B), is applied to the element 24, or is otherwise interposed between the second electrically conductive planer layer 28 and the coil/antenna. As can be most clearly seen in FIG. 14, the insulator layer 28 isolates the element 24 from turn tracks 13 and 14, while electrical connection of the capacitor strap 20 is made at connections 25A and 25B at ends 22B and 24B of the capacitor strap 20 to coil tracks 11 and 12, respectively. It should be noted that where a coil of less than one turn is provided, the insulator layer 28 is not required since the capacitor strap 20 does not crossover any other coil tracks. Thus, an EAS tag or inlay 16 is created having an equivalent circuit formed by the coil 10 and the capacitor strap 20.

In a further embodiment, shown in FIGS. 15 and 16, a deactivatable resonant circuit 120 is positioned within a stopper or cap of a bottle or container. In particular, the resonant circuit 120 comprises an RF wound coil and permanently deactivatable capacitor that resonates preferably at (but is not limited in any way to) 8.2 MHz. However, unlike existing RF wound coil/capacitor circuits, the circuit 120 is permanently deactivatable with conventional deactivation equipment (e.g., Checkpoint's COUNTERPOINT deactivator equipment).

FIG. 15 depicts an exemplary bottle closure 102 (e.g., Zork® cork or wine closure manufactured by Zork® Pty Ltd of Australia) that can house the deactivatable resonant circuit 120 of the present invention. In particular, the closure comprises a stopper 104 comprising a cavity 106 into which the deactivatable resonant circuit 120 is positioned and secured therein (e.g., using an adhesive or a plurality of fingers, etc., that are present on the inner wall of the cavity 106). A seal 108 is sealed over the opening to the cavity 106. The stopper 104 is then positioned inside the opening of the bottle B (FIG. 16) and then a cap cover 110 with a tear-away portion is applied around the bottle top, thereby completing the bottle closure 102. FIG. 16 is an enlarged view of the top of an exemplary bottle B having the bottle closure 102 applied thereto and shown in cross-section to reveal the placement of the deactivatable resonant circuit 120 therein. It should be understood that the circuit 120 shown in FIGS. 15-16 is not limited to the circuit shown but includes any of the embodiments disclosed in the instant application and any equivalents thereof.

As mentioned previously, the deactivatable resonant circuit 120 of the present invention is not limited to bottle closures but may be used in container closures (caps, lids, etc. where cavities are provided therein). In addition, the deactivatable resonant circuit 120 may be positioned in other retail items where the circuit 120 can be concealed without a tactile detection (e.g., lining or collars of coats, padding, etc.).

The RF wound coil/capacitor circuit 120 comprises an LC circuit as described herein where the wound coil is an inductor (L) and a capacitor (C) is connected to each end of the coil. The inductor is created using a thin wire (aluminum or copper) with an insulating layer (preferable polyethylene) to prevent shorting of the coil

To make the RF wound coil/capacitor circuit 120 deactivatable, the circuit comprises a capacitor with a dielectric breakdown voltage in the range of 3 to 10 volts DC. A ceramic capacitor can be used or any other permanently deactivatable capacitor with the appropriate breakdown voltage. When the predetermined minimum deactivation field strength is applied to the LC circuit, the voltage across the capacitors plates exceeds the desired breakdown voltage and a short is created across the capacitor plates. The LC circuit will therefore no longer resonate at the proper frequency and is permanently deactivated.

It should be noted that although the figures depict EAS style security tags, it is within the broadest scope of the present invention to include RFID chips as part of the security tag.

It should be further noted that any of the above embodiments can also be practiced by having two or more capacitors in series. In this case each of capacitors must be permanently disableable when a dielectric break down occurs to a particular capacitor, or the dielectric breakdown voltage of all permanently disableable capacitors in the circuit must be lower than the dielectric breakdown voltage of any capacitors that are not permanently disableable. For example, the resonant tag describe above, having an inductor formed on a planar substrate can also have a capacitor formed on the substrate. As noted above, however, capacitors formed by a conventional prior art methods have the potential to “self heal” over time after dielectric breakdown. Thus, for the resonant circuit to be permanently disabled, the capacitor that breaks down must not be capable of self healing. If a ceramic capacitor (or other non-self-healing type) is used in series with a self-healing capacitor, and the ceramic capacitor has a guaranteed breakdown voltage that is lower than that for the self-healing capacitor, then the resonant circuit will always be permanently disabled when exposed to a voltage sufficient to cause breakdown in the ceramic capacitor. Such an embodiment can be used where accurate control of total tag resonant frequency is desirable and the capacitor formed on the tag substrate can be trimmed to vary the resonant frequency, especially where the ceramic capacitor and/or the inductor have manufacturing tolerances that are larger than acceptable to maintain the desired resonant frequency. Trimming a prior art self-healing capacitor formed on a flexible security tag substrate by methods such as laser trimming, etching, and cutting is well known in the art. For example see U.S. Pat. No. 7,119,685.

While the invention has been described in detail and with reference to specific examples thereof, it will be apparent to one skilled in the art that various changes and modifications can be made therein without departing from the spirit and scope thereof.

What is claimed is:

1. A resonant circuit which resonates with a radio wave within a predetermined resonant frequency range, comprising:
an inductor; and
a capacitor having a predetermined dielectric breakdown voltage;
wherein said inductor and capacitor form an LC circuit and wherein said resonant circuit is permanently disabled by inducing a voltage to said capacitor that exceeds said predetermined breakdown voltage; and
wherein said capacitor comprises a dielectric made from one of the group consisting of: a ceramic, a metal oxide, a mineral.

2. The resonant circuit according to claim 1, wherein said dielectric has a thickness range between 60 and 2000 angstroms.

3. The resonant circuit of claim 1, wherein said breakdown voltage is in the range between three and ten volts DC.

4. The resonant circuit of claim 1 wherein the predetermined resonant frequency is 5 to 15 MHz.

5. The resonant circuit of claim 1, wherein the resonant circuit is a tag and said inductor is a coil formed on a substantially planer substrate.

6. The resonant circuit of claim 1, wherein said inductor is a coil of wound wire.

7. A resonant tag comprising:
a substrate having a first principal surface;
a resonant circuit which resonates with a radio wave within a predetermined resonant frequency range, the resonant circuit comprising an inductor formed on said first principal surface of said substrate; said inductor connected in series with a capacitor having a predetermined breakdown voltage;
wherein said resonant circuit is permanently disabled by applying an induced voltage to said capacitor that exceeds said predetermined breakdown voltage; and
wherein said capacitor comprises a dielectric made from one of the group consisting of: a ceramic, a metal oxide, a mineral.

8. The resonant tag of claim 7 wherein said capacitor is a capacitor formed on a silicon-based substrate that is affixed to said first principal surface and electrically connected to said inductor by wire bonding.

9. The resonant tag of claim 7 wherein said capacitor is affixed to said first principal surface and is a capacitor suitable for surface mount device attachment.

10. The resonant tag of claim 7 wherein said capacitor is formed on a strap;
said strap comprising a thin, generally planar member comprising a first electrically conductive planar element, a second electrically conductive planar element and said dielectric disposed between portions of said first and second electrically conductive planar elements, and
wherein said strap is electrically connected to said inductor to form an LC circuit.

11. The resonant tag of claim 7, wherein said capacitor is physically affixed to a strap, said strap having a first electrically conductive planar element and a second electrically conductive planar element, wherein said capacitor is electrically connected to said first and second electrically conductive elements and said strap is electrically connected to said inductor to form an LC circuit.

12. The resonant tag of claim 7, wherein said predetermined breakdown voltage is in the range of 3 to 10 volts DC.

14. The resonant tag of claim 7, wherein said a predetermined resonant frequency range is between 5 and 15 MHZ.

15. A circuit element adapted for use in a resonant circuit comprising:
a strap having two electrically conductive ends wherein said electrically conductive ends are connected to each other by a dielectric material forming a capacitor having a predetermined breakdown voltage and wherein said dielectric material is selected from the group consisting of a ceramic, a metal oxide, and a mineral.

16. The circuit element of claim 15, wherein said strap comprises a first electrically conductive planar element, a second electrically conductive planar element and wherein said first and second planar elements overlap and said dielectric is disposed between overlapping portions of said first and second electrically conductive planar elements.

17. The circuit element of claim 15, wherein said strap comprises two electrically conductive planar elements physically connected together with an insulating material and wherein said dielectric material is a discrete component capacitor that has one lead wire bonded to each of said electrically conductive planar elements.

18. The circuit element of claim 15, wherein said strap comprises two electrically conductive planar elements physically connected together with an insulating material and wherein said dielectric material is a discrete component capacitor that is adapted for attachment to said electrically conductive planer elements as a surface mount device.

19. The circuit element of claim 18 wherein said capacitor is electrically connected to said electrically conductive planar elements with a conductive adhesive.

20. The circuit element of claim 18 wherein said capacitor is electrically connected to said electrically conductive planar elements with solder.
